(19) United States
(12) Patent Application Publication
(10) Pub. No.: US 2015/0360643 A1
(43) Pub. Date: Dec. 17, 2015

(54) OCCUPANT SENSING AND CLASSIFICATION SYSTEM

(71) Applicant: TK Holdings Inc., Auburn Hills, MI (US)

(72) Inventors: Leonard S. CECH, Brighton, MI (US); Phillip MAGUIRE, Royal Oak, MI (US)

(73) Assignee: TK Holdings Inc., Auburn Hills, MI (US)

(21) Appl. No.: 14/738,241

(22) Filed: Jun. 12, 2015

Related U.S. Application Data
(60) Provisional application No. 62/012,056, filed on Jun. 13, 2014.

(51) Int. Cl. B60R 22/48; B60N 2/00; G01V 3/00; B60R 21/015

(52) U.S. Cl. CPC B60R 22/48; B60R 21/01516; B60R 21/01542; B60R 21/01546; B60N 2/002; G01V 3/00; B60R 2022/4808

(57) ABSTRACT

A detection and classification system for detecting an occupant of a vehicle seat. The system includes a webbing, a controller and a first sensing electrode coupled to the webbing. The system also includes a second sensing electrode located in the vehicle seat. The first and second sensing electrodes are operatively coupled to the controller. The controller includes a signal generator that provides time varying voltages to the first and second sensing electrodes. The controller is configured to detect changes in the time vary voltages resulting from the electrodes being located in proximity to the occupant. The controller is configured to detect the occupant moving position or the occupant being out of position.

### CROSS REFERENCE TO RELATED APPLICATIONS

The present application claims priority to and the benefit of U.S. Provisional Patent Application No. 62/012,056 filed Jun. 13, 2014. The foregoing provisional application is incorporated by reference herein.

### BACKGROUND

The present application relates generally to the field of occupant classification systems for vehicle seating. Vehicle seats may include occupant classification systems to attempt to determine if the seat is occupied by an adult, a child, or no one. Certain occupant classification systems discriminate adults from child restraint systems using a sensor mat capacitive or electric field type sensor located in the seat bottom of a vehicle seat. In certain systems, the signal received from the sensor may be used to discriminate between conductive objects.

Seat belt use can be tracked using devices, such as belt buckle switches, and seat-belt webbing payout monitoring sensors. Such webbing payout monitoring sensors may be incorporated within a motorized seat belt or a passive seat belt system.

### SUMMARY

One exemplary embodiment disclosed is directed to a seat belt system for restraining an occupant of a vehicle. The system includes a webbing and a controller. A sensing electrode is coupled to the webbing. The sensing electrode is also operatively coupled to the controller, which is configured to determine whether the webbing is located in a proper position to restrain the occupant during a frontal crash. The system may include a shielding electrode coupled to the webbing and positioned on the opposite side of the sensing electrode from the occupant when the seat belt is properly worn.

Another exemplary embodiment is directed to a system for detecting an occupant of a vehicle seat. The system includes a webbing and a webbing and a controller. The system also includes a first sensing electrode coupled to the webbing and a second sensing electrode located in the vehicle seat. The sensing electrodes are operatively coupled to the controller, which includes a signal generator that provides time varying voltages to the sensing electrodes. The controller is configured to detect changes in the time vary voltages resulting from the electrodes being located in proximity to the occupant. The controller also may detect the occupant moving position or the occupant being out of position based on the detected changes in the time varying voltages.

It is to be understood that both the foregoing general description and the following detailed description are exemplary and explanatory only, and are not restrictive of the invention as claimed.

### BRIEF DESCRIPTION OF THE DRAWINGS

Features, aspects, and advantages of the present invention will become apparent from the following description, appended claims, and the accompanying exemplary embodiments shown in the drawings, which are briefly described below.

FIG. 1 is a schematic perspective view of a vehicle seat including an occupant detection system, according to an exemplary embodiment.

FIG. 2 is a schematic side view of a vehicle seat including an occupant detection system, according to an exemplary embodiment.

FIG. 3 is a schematic perspective view of a vehicle seat including an occupant detection system with an improperly positioned seat belt, according to an exemplary embodiment.

FIG. 4 is a schematic perspective view of a vehicle seat including an occupant detection system with a seat belt system not in use, according to an exemplary embodiment.

FIG. 5 is a schematic view of a vehicle seat including an occupant detection system with a seat belt system with a connection to a vehicle communications.

### DETAILED DESCRIPTION

An occupant classification sensor for a vehicle seat includes multiple sensors located within the seat (e.g., the seat back and the seat bottom) and coupled to the seat belt webbing of a seat belt system. The sensors may be sensors known in the art such as capacitive or electric field sensors. By using capacitive or electric field sensors in the seat belt, use of the seat belt system may be determined without the inclusion of a continuous belt length payout sensor in a retractor of the seat belt system.

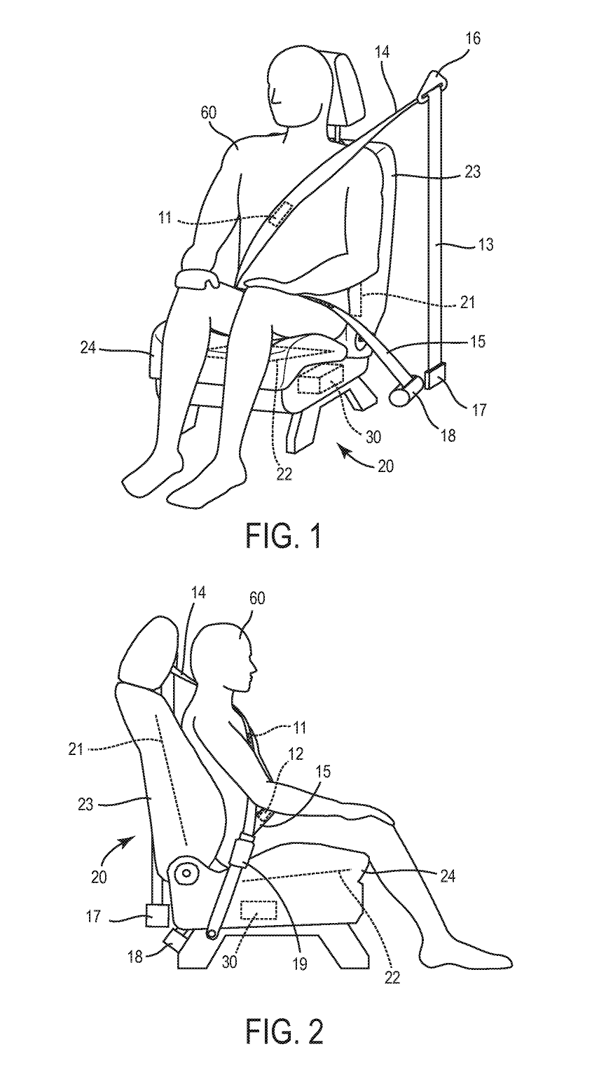

Referring to FIGS. 1-2, a vehicle seat 20 is shown according to an exemplary embodiment. One or more seats that are configured to receive an occupant 60 may be provided in a vehicle. The vehicle seat includes a generally horizontal lower portion or seat bottom 24 that is coupled to the vehicle and an upper portion or seat back 23 that extends upward from the rear end of the seat bottom 24. The seat back 23 may be connected to the seat bottom 24 through a recliner mechanism that allows the seat back 23 to tilt or pivot relative to the seat bottom 24. Each of the seat bottom 24 and the seat back 23 may include a supporting frame, a cushion such as a foam pad that is coupled to the frame, and a trim cover that surrounds the cushion. The vehicle seat includes an occupant classification system. The occupant classification system is configured to detect an occupant of a vehicle seat and classify the occupant, such as by classifying the occupant as an adult, a child, or no one (e.g., an empty seat or a seat containing an object).

According to an exemplary embodiment, the occupant classification system may include an electric field sensor (e.g., an electrode) 22 in the seat bottom. The occupant classification system measures the impedance from an electrode in the seat bottom cushion with respect to ground. With such a topology, the impedance from sensor to ground with an adult occupant (e.g., a 5 percentile female) or a sufficiently large child (e.g., 6 year old or older) sitting on the seat is relatively low due to the conductive nature of the human body. The adult occupant may be classified as “Large/On”. If the seat is occupied by a typical child in a typical child restraint system or a typical child in a typical booster seat or if the seat is empty, the impedance from the sensor to ground is relatively high, resulting in a classification of “Small/Off”.

The system disclosed herein may use an electric field sensor (e.g., an electrode) 21 situated in the seat back to allow for desired discrimination of the seat occupancy type, including the above scenarios, for proper seat belt reminder function and airbag deployment activation. The seat back sensor 21 may be monitored separately from other sensors in the seat to discriminate conductive objects on the seat from occupants, or may be monitored in conjunction with other sensors. It should be understood that the occupant classification system including the seat back sensor 21 as described in the present disclosure may or may not include other sensors as part of the occupant classification process.

The impedance from the sensing electrode 22 in the seat bottom and/or the impedance from the sensing electrode in the seat back 21 with respect to ground is measured. With an adult occupant (e.g., a 5% female) or a 6 year old (or older) sitting directly on the seat or in a booster without a seat back, the occupant's back or buttocks is proximate to the seat back electrode. The impedance from sensor to ground with an adult occupant, or a sufficiently large child is relatively “low” due to the conductive nature of the human body. The occupant classification system classifies the adult occupant (e.g., 5% female or 6 year-old directly on seat) as “Large/On”. If the seat is occupied by a typical child in a typical child restraint system or a typical child in a typical booster seat or if the seat is empty, the impedance from the sensor to ground is relatively high, resulting in a classification of “Small/Off”. Further, a conductive object, such as a laptop of other electronic device on the seat, will likely not be proximate to the seat back electrode 21 and hence will result in a high impedance between the seat back sensor 21 and ground. The result is a classification equal to “Small/Off” (e.g., a classification such as “Object Not Present/Off” or similar). The “Small/Off” classification may result in the desired suppression of the audible seat belt reminder, for example. While impedance is referenced herein, it should be understood that the measurement and processing circuitry may detect or measure current from sensor to ground, because current and impedance are directly related.

The seat bottom sensor 22 may be connected to an electronic control unit (ECU) 30. The ECU is connected to a vehicle communication bus 40, which is connected to the other vehicle systems (e.g., airbag system, seat belt reminder system, etc.) 50. While the ECU 30 is shown schematically as being provided under the seat bottom, in various embodiments the ECU 30 and other components of the occupant classification system may be provided elsewhere in the vehicle, such as in the vehicle dash, in a center console, etc. The ECU 30 may generally be configured to receive and measure sensor readings from the seat back sensor to classify the occupant or object in the seat. For example, the ECU 30 may send a time-varying voltage to the seat bottom sensor and measure the in-phase and quadrature components of the current that change as a result of the change of impedance to ground, and to classify the occupant or object based on the measurement. The ECU 30 may include the signal processing circuitry to conduct the required measurements and detection of the current components necessary for analyzing the presence (or lack thereof) an occupant in the seat.

According to an exemplary embodiment, the occupant classification system may further includes a seat belt sensor electrode coupled to a seat belt system. The seat belt system generally includes a belt (e.g. webbing, strap, etc.) 13, extending between a fixed floor anchor 17 and a retractor 18. A tongue is positioned along the webbing, with the tongue configured to engage a buckle 19. Upon attaching the tongue to the buckle, the belt is latched across the vehicle occupant to secure the occupant to the vehicle seat. A lap portion of the webbing 15 extends from the retractor to the tongue and is positioned across the lap of the occupant. A shoulder portion of the webbing 14 extends from the tongue through a shoulder anchor (e.g., D-ring, automatic turning loops, etc.) 16 and to the fixed anchor 17 and is positioned across the chest and shoulder of the occupant. The occupant classification may include a sensor (e.g., an electrode) 12 coupled to the lap portion of the seat belt webbing and/or a sensor (e.g., an electrode) 11 coupled to the shoulder portion of the seat belt webbing.

In one exemplary embodiment, the seat belt sensor electrodes may include conductive members (e.g., threads) woven directly into the webbing and extending along the length of the webbing to the ECU. In another exemplary embodiment, the seat belt sensor electrodes may include a conductive member (e.g., conductor pad) that is coupled (e.g., printed, adhered, etc.) to the outside of the webbing and coupled to the ECU 30 via conductive paths (e.g., wires, printed conductors, etc.) on the surface of the webbing. In another exemplary embodiment, the seat belt sensor electrodes may include a conductive member (e.g., conductor pad) that are inserted inside tubular webbing and coupled to the ECU 30 via conductive paths (e.g., wires, printed conductors, etc.) provided inside the tubular webbing.

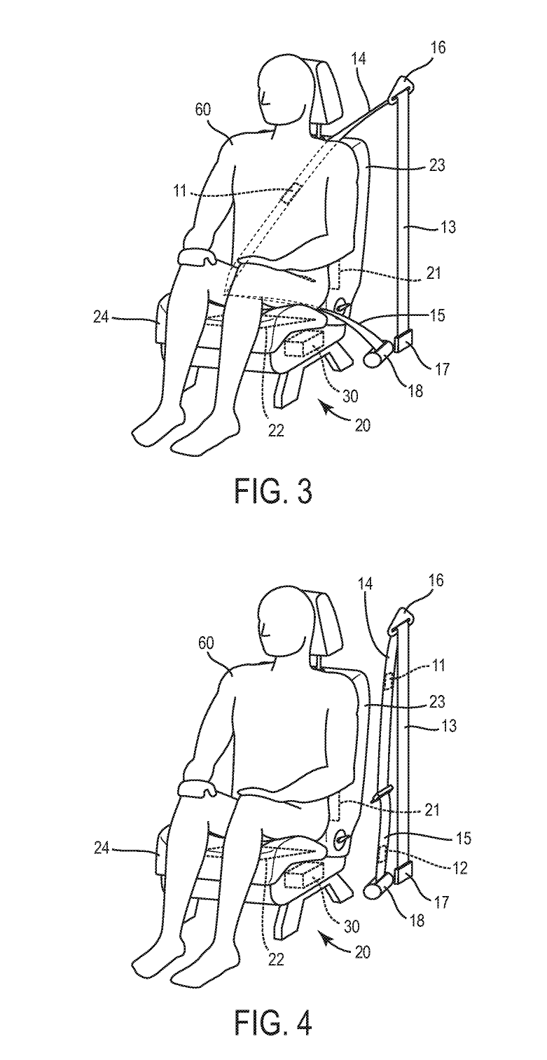

The ECU 30 may generally be configured to receive and measure sensor readings from the seat belt sensors to determine that the seat belt system is being used correctly with the lap portion and shoulder portion of the seat belt webbing properly positioned relative to the occupant, as shown in FIGS. 1-2, or improperly positioned/not in use, as shown in FIG. 3. For example, the ECU 30 may send a time-varying voltage to the seat belt sensor and measure the in-phase and quadrature current components of the signal, in order to determine the positioning of the seat belt webbing and/or the classification of the occupant or object in the seat. For example, the system may use the same concepts described in U.S. Patent Publication No. US2007-0192007 (incorporated by referenced herein). The ECU 30 may monitor the absolute and/or relative signals associated with the seat bottom, seat back, and seat belt. The signals may be monitored continuously or may be monitored at discreet intervals (e.g., before the seat belt is buckled, as the seat belt is being extracted, after the seat belt is buckled, etc.). The ECU 30 may detect other signals such as the vehicle state or the state of belt switches via a vehicle communication bus 40 (e.g., a CAN bus).

In the situation where the seat belt is worn improperly, as shown in FIG. 3, the seat belt sensors will provide a different indication to the ECU. For example, the sensors may only be inward “looking” or sensing. The sensors may include a shield layer or electrode located on the outer or top side of the conductor or conductive layer. As described in U.S. Pat. No. 8,896,236 (incorporated by reference herein), the shield layer or electrode effectively prevents the sensor from being affected by a conductor (i.e., an interfering structure) located on the opposite side of the shield from sensing electrode. Typically, a driven shield electrode receiving the same or similar time varying voltage signal as the sensing electrode may be used as the shield. In the instance when the occupant is sitting on the lap belt, instead of wearing the lap belt across the lap (See FIG. 3, for example), the shield effectively prevents the sensor from being influenced by the proximity of the occupant and the shield. The ECU would determine that no occupant was present in the seat (based solely on the webbing sensors).

In addition, a seat belt buckle or engagement sensor could be used to provide an indication when the seat belt is buckled. If the seat belt buckle sensor indicates that the tongue is engaged with the buckle, and the belt webbing sensors indicate that no occupant is present, the ECU may determine that the seat belt is being worn improperly. Any suitable seat belt buckle sensor may be utilized such as, for example, a hall effect sensor, an electric field sensor, etc. Similarly, a seat bottom sensor and/or a seat back sensor may be used in combination with the seat belt sensors in order to provide the ECU with an indication regarding both the presence of the occupant and whether the occupant is properly wearing the seat belt.

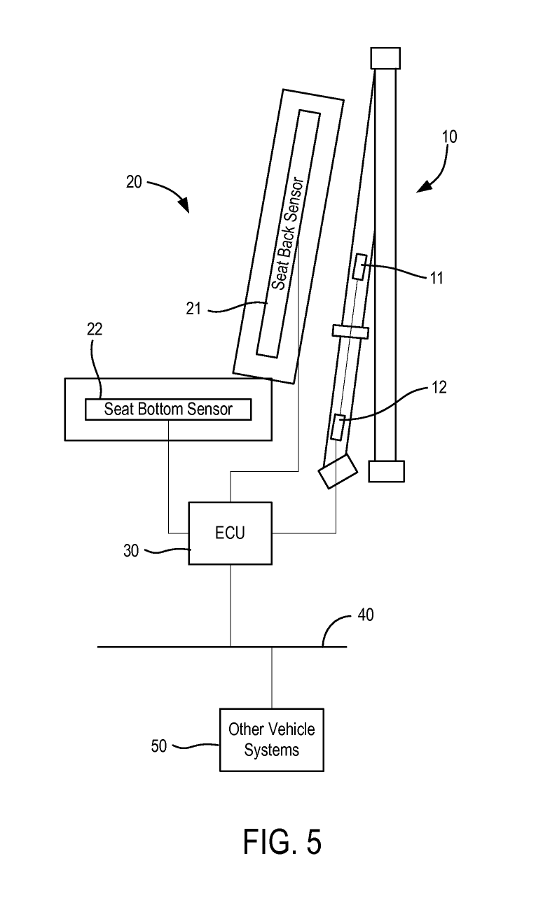

Referring to FIG. 5, the occupant and belt use condition may be communicated by the ECU 30 to other vehicle systems (e.g., interlock systems, warning systems, etc.) and used by the other vehicle systems. The occupant and belt use conditions may be used by the other vehicle systems based on the vehicle state. In some embodiments, the occupant and belt use conditions may be communicated to the vehicle systems in real time. In some embodiments, the occupant and belt use conditions may be filtered based on various criteria. In some embodiments, the occupant and belt use conditions may be statistically discriminated.

In some embodiments, the occupant classification system may include additional seat belt sensors coupled to the seat belt webbing that are provided in defined locations and have geometries to facilitate the detection of anomalous positioning of the webbing (e.g., twisted webbing, loose webbing, etc.).

In some embodiments, the occupant classification system may include additional seat belt sensors coupled to the seat belt webbing 13 that are configured to be monitored in real time to detect a moving passenger or an out of position passenger (e.g., leaning forward, leaning back, leaning left, leaning right, etc.). The occupant classification system may detect a moving passenger or an out of position passenger when the vehicle is moving or when the vehicle is stationary (e.g., to detect an occupant left in a stationary car, to detect movement of a passenger after a collision, etc.).

In other embodiments, the occupant classification system may not include a seat bottom sensor or seat back sensor. Instead, the detection, and classification of the occupant and the detection of proper seat belt use may be accomplished solely by using one or more sensors coupled to the seat belt.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

The construction and arrangement of the elements of the method for removable component as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements, the position of elements may be reversed or otherwise varied, and the nature or number of discrete elements or positions may be altered or varied. It should be noted that the elements and/or assemblies of the system may be constructed from any of a wide variety of materials that provide sufficient strength or durability. Components such as those shown herein may be used in non-vehicle applications as well. Other substitutions, modifications, changes and omissions may be made in the design, operating conditions and arrangement of the preferred and other exemplary embodiments without departing from the scope of the present invention.

What is claimed is:

1. A seat belt system for restraining an occupant of a vehicle comprising:
a webbing;
a controller;
a sensing electrode coupled to the webbing;
wherein the sensing electrode is operatively coupled to the controller; and
wherein the controller is configured to determine whether the webbing is located in a proper position to restrain the occupant during a frontal crash.

2. The system of claim 1, wherein the sensing electrode includes a conductor woven into the webbing.

3. The system of claim 1, wherein the sensing electrode includes a conductor connected to the surface of the webbing.

4. The system of claim 1, further comprising a shielding electrode coupled to the webbing and positioned on the opposite side of the sensing electrode from the occupant when the seat belt is properly worn.

5. The system of claim 1, wherein webbing includes a shoulder portion and a lap portion, wherein the sensing electrode is coupled to the shoulder portion.

6. The system of claim 4, further comprising a second sensing electrode coupled to the lap portion.

7. The system of claim 1, wherein the controller is configured to provide an indication signal when the webbing is not located in a proper position.

8. The system of claim 1, further comprising a signal generator that provides a time varying signal to the sensing electrode.

9. The system of claim 8, wherein the controller includes the signal generator.

10. The system of claim 8, wherein the signal generator provides the time varying signal to a shielding electrode coupled to the webbing and positioned on the opposite side of the sensing electrode from the occupant when the seat belt is properly worn.

11. The system of claim 8, wherein the controller includes signal processing circuitry to detect changes in the signal to the sensing electrode resulting from the occupant being located proximate to the sensing electrode.

12. The system of claim 1, further comprising a buckle coupled to the webbing and a tongue coupled to the webbing, and a seat buckle sensor, wherein the seat buckle sensor is configured to detect the engagement of the buckle and the tongue.

13. A detection system for detecting an occupant of a vehicle seat comprising:
a webbing;
a controller;
a first sensing electrode coupled to the webbing;
a second sensing electrode located in the vehicle seat;
wherein the first and second sensing electrodes are operatively coupled to the controller; and
wherein the controller includes a signal generator that provides time varying voltages to the first and second sensing electrodes; and
wherein the controller is configured to detect changes in the time vary voltages resulting from the electrodes being located in proximity to the occupant and wherein the controller is configured to detect the presence of the occupant.

14. The detection system of claim 13, wherein the controller includes a signal processor configured to measure a current in the first sensing electrode and classify the occupant of the seat.

15. The detection system of claim 14, wherein the controller is configured to classify the occupant of the seat in order to distinguish between an adult and a rear facing infant seat.

16. The detection system of claim 13, wherein the first sensing electrode includes a conductor connected to the surface of the webbing.

17. The detection system of claim 13, wherein the webbing includes a shoulder portion and a lap portion, wherein the first sensing electrode is coupled to the shoulder portion.

18. The detection system of claim 17, further comprising a third sensing electrode coupled to the lap portion.

19. The detection system of claim 13, wherein the controller is configured to provide an indication signal when the webbing is not located in a proper position.

20. The detection system of 13, wherein the signal generator provides the time varying signal to a shielding electrode coupled to the webbing and positioned on the opposite side of the first sensing electrode from the occupant when the seat belt is properly worn.
